(19) United States
(12) Patent Application Publication
(10) Pub. No.: US 2020/0399162 A1
(43) Pub. Date: Dec. 24, 2020

(54) DRAWING SYSTEM FOR POLYGONAL OPTICAL FIBER

(71) Applicant: SUCCESS PRIME CORPORATION, CHU-NAN (TW)

(72) Inventors: KUEI-HUANG CHOU, CHU-NAN (TW); ZHAO-YING CHEN, CHU-NAN (TW)

(21) Appl. No.: 16/702,579

(22) Filed: Dec. 4, 2019

(30) Foreign Application Priority Data
Jun. 21, 2019 (TW) 108121767

(51) Int. Cl. C03B 37/029; C03B 37/012

(52) U.S. Cl. CPC C03B 37/029; C03B 37/0124

(57) ABSTRACT

A drawing system for polygonal optical fiber is provided, comprising: a clamping moving device, a furnace, a protective layer coating device, at least a protective layer drying system, and a fiber take-up device, all arranged from top to bottom; the clamping moving device clamping a polygonal preform rod and slowly moving the preform rod into the furnace; a polygonal optical fiber extracted from bottom of the furnace passing sequentially through the protective layer coating device, the protective layer drying system, and finally the fiber take-up device controlling drawing speed of the polygonal optical fiber, characterized in that: at least two optical fiber micrometers being disposed between the furnace and the protective layer coating device, and the two optical fiber micrometer respectively measuring two outer diameters of different sizes of the polygonal optical fiber; the fiber take-up device adjusting the drawing speed according to measurement results of the optical fiber micrometers.

### CROSS-REFERENCE TO RELATED APPLICATION

This application claims the priority of Taiwanese patent application No. 108121767, filed on Jun. 21, 2019, which is incorporated herewith by reference.

### BACKGROUND OF THE INVENTION

### 1. Field of the Invention

The present invention relates generally to a drawing system for optical fiber, and particularly relates to a drawing technique for a polygonal optical fiber, able to maintain the design of the outer diameter uniformity of the optical fiber during the drawing process.

### 2. The Prior Arts

An optical fiber drawing tower is for fiber drawing operation. The operation of the optical fiber drawing tower is as follows: a preform rod is clamped by a clamping moving device, and the preform rod is slowly fed into the high-temperature furnace, and the optical fiber is continuously pulled out from the lower side of the high-temperature furnace through the capstan and the optical fiber take-up device. In the process of drawing, a protective layer should be coated in time to preserve the strength of the fiber. The way to control the outer diameter of the fiber is to adjust the drawing speed by using the feedback on the outer diameter of the fiber from a laser micrometer to stabilize the fiber outer diameter. The existing drawing system adopts a single laser micrometer, which performs well in the feedback control of a circular optical fiber. However, when detecting the polygonal optical fiber, the feedback signal will be unstable due to the twist of the optical fiber, resulting in extremely poor uniformity in drawing the optical fiber. To this end, the inventor considered an improved method.

### SUMMARY OF THE INVENTION

A primary objective of the present invention is to provide a drawing system for polygonal optical fiber, which uses a plurality of optical fiber micrometers to measure the outer diameter of the drawn fiber and adjust the drawing speed to obtain a polygonal fiber with good outer diameter uniformity.

For achieving the foregoing objectives, the present invention provides a drawing system for polygonal optical fiber, comprising: a clamping moving device, a furnace, a protective layer coating device, at least a protective layer drying system, and a fiber take-up device, all arranged from top to bottom; the clamping moving device clamping a polygonal preform rod and slowly moving the preform rod into the furnace; a polygonal optical fiber extracted from bottom of the furnace passing sequentially through the protective layer coating device, the protective layer drying system, and finally the fiber take-up device controlling drawing speed of the polygonal optical fiber, characterized in that: at least two optical fiber micrometers being disposed between the furnace and the protective layer coating device, and the two optical fiber micrometer respectively measuring two outer diameters of different sizes of the polygonal optical fiber; the fiber take-up device adjusting the drawing speed according to a plurality of measurement results of the optical fiber micrometers.

In a preferred embodiment of the present invention, the two outer diameters of the different sizes are the largest and smallest outer diameters of the polygonal optical fiber.

In a preferred embodiment of the present invention, two adjacent optical fiber micrometers are disposed at an angle of 10 to 60 degrees.

In a preferred embodiment of the present invention, when the polygonal optical fiber is quadrilateral, the two adjacent optical fiber micrometers are disposed at an angle of 33 to 57 degrees.

In the preferred embodiment of the present invention, when the polygonal optical fiber is hexagonal, the two adjacent optical fiber micrometers are disposed at an angle of 21 to 39 degrees.

In the preferred embodiment of the present invention, when the polygonal optical fiber is octagonal, the two adjacent two optical fiber micrometers are disposed at an angle of 16.5 to 28.5 degrees.

In a preferred embodiment of the present invention, the plurality of the fiber optic micrometers is located adjacent to an exit region of the furnace.

In a preferred embodiment of the present invention, the fiber optic micrometer is a laser micrometer.

In a preferred embodiment of the present invention, at least a protective layer micrometer is disposed between the protective layer drying system and the fiber take-up device.

In a preferred embodiment of the present invention, the protective layer micrometer is a laser micrometer.

In summary, the present invention has the following effects:

1. Measuring the outer diameter of the polygonal optical fiber by a plurality of optical fiber micrometers, so as to control the drawing speed, and solve the phenomenon of twisting or shaking of the optical fiber during the drawing, resulting in an optical fiber with good outer diameter uniformity;

2. A polygonal optical fiber with stable outer diameter can be obtained at a lower equipment investment cost.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a schematic view of a structure of the drawing system for polygonal optical fiber according to the present invention;

FIG. 2 shows a top view of two adjacent optical fiber micrometers according to the present invention;

FIG. 3 shows a diagram of the variation of the outer diameter measured by two adjacent optical fiber micrometers according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

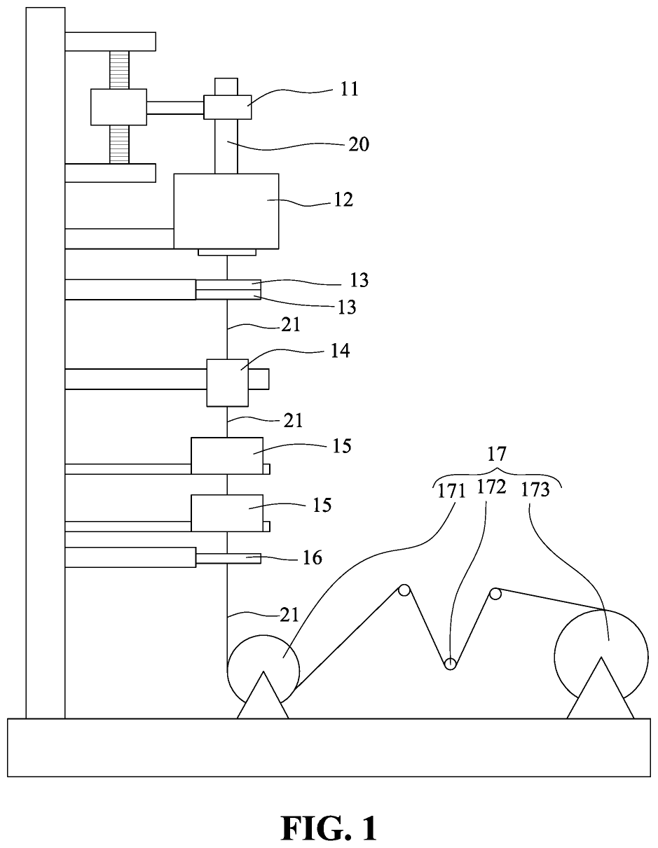

Referring to FIG. 1, shows a schematic view of a structure of the drawing system for polygonal optical fiber according to the present invention. The drawing system for polygonal optical fiber comprises: a clamping moving device 11, a furnace 12, at least two optical fiber micrometers 13, a protective layer coating device 14, at least a protective layer drying system 15, a protective layer micrometer 16, and a fiber take-up device 17, all arranged from top to bottom.

The clamping moving device 11 is responsible for clamping a polygonal preform rod 20 of optical fiber, and an internal driving mechanism drives the clamping moving device 11 to slowly move the polygonal preform rod 20 into the furnace 12. The furnace 12 is a high-temperature heating furnace, with a temperature up to 1600-2200° C.; and with a specifically shaped exit at the bottom of the furnace 12, a polygonal optical fiber 21 of 115-135 μm can be extracted. The extracted polygonal optical fiber 21 passes through the protective layer coating device 14 and the two protective layer drying systems 15 to obtain a protective layer to strengthen the polygonal optical fiber 21. The fiber take-up device 17 comprises a driving wheel 171, a plurality of steering wheels 172, and a spooling wheel 173, to control the drawing speed and collect the polygonal fiber. In FIG. 1, the clamping moving device 11, the furnace 12, the protective layer coating device 14, and the protective layer drying system 15 can be existing equipment, and the depiction shown in FIG. 1 is simplified.

The main design feature of the present invention is to provide at least two fiber optic micrometers 13. A plurality of the optical fiber micrometers 13 is disposed adjacent to the exit region of the furnace 12. At least two of the optical fiber micrometers 13 are configured to respectively measure the at least two outer diameters of the different sizes of the polygonal optical fibers 21. In the present embodiment, the two outer diameters of the different sizes are the largest and smallest outer diameters of the polygonal optical fiber 21. The optical fiber take-up device 17 adjusts the drawing speed according to the computation result from a computer program based on a plurality of measurements by the optical fiber micrometers 13 to maintain the uniformity of the outer diameter of the polygonal optical fiber 21 during the drawing process.

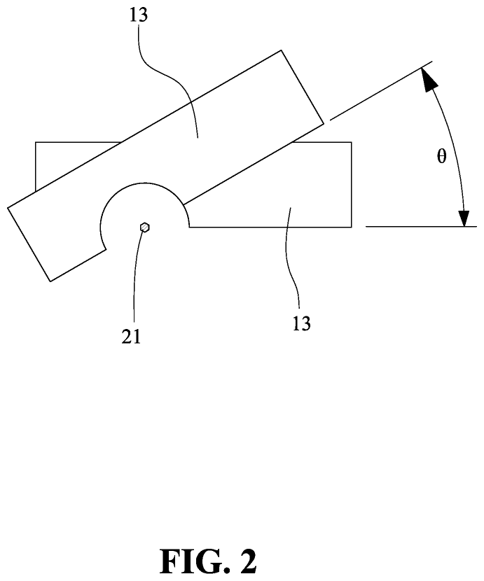

As shown in FIG. 2, FIG. 2 shows top view of two adjacent optical fiber micrometers 13 included in the present invention. When measuring different outer diameters of the polygonal optical fiber 21, the adjacent two optical micrometers 13 are offset by an angle θ. In the present embodiment, the optical fiber micrometer 13 is a laser micrometer, and the angle θ is 10 to 60 degrees. The actual angle θ depends on the shape of the polygonal optical fiber.

For example, when the polygonal optical fiber 21 is quadrangular, the two adjacent optical fiber micrometers 13 are disposed at an angle θ of 33 to 57 degrees, and the optimum angle is 45 degrees.

When the polygonal optical fiber 21 is hexagonal, the two adjacent optical fiber micrometers 13 are disposed at an angle θ of 21 to 39 degrees and the optimum angle is 30 degrees.

When the polygonal optical fiber 21 is octagonal, the two adjacent optical fiber micrometers 13 are disposed at an angle θ of 16.5 to 28.5 degrees and the optimum angle is 22.5 degrees.

The function of using an offset angle between the above two optical fiber micrometers 13 is to obtain the maximum and minimum outer diameter of the polygonal optical fiber 21 or the sizes of outer diameter at two different positions to ensure whether the polygonal optical fiber 21 is twisted or shaken during drawing; and if there is any twisting or shaking, the present invention utilizes the feedback information on outer diameter of the plurality of optical fiber micrometers 13 to adjust the drawing speed of the fiber take-up device 17 in real-time, to maintain the drawing quality, and obtain the polygonal optical fiber 21 with good uniformity.

Furthermore, at least one protective layer micrometer 16 is provided between the protective layer drying system 15 and the fiber take-up device 17. The protective layer micrometer 16 is a laser micrometer for measuring the circular outer diameter after coating the protective layer.

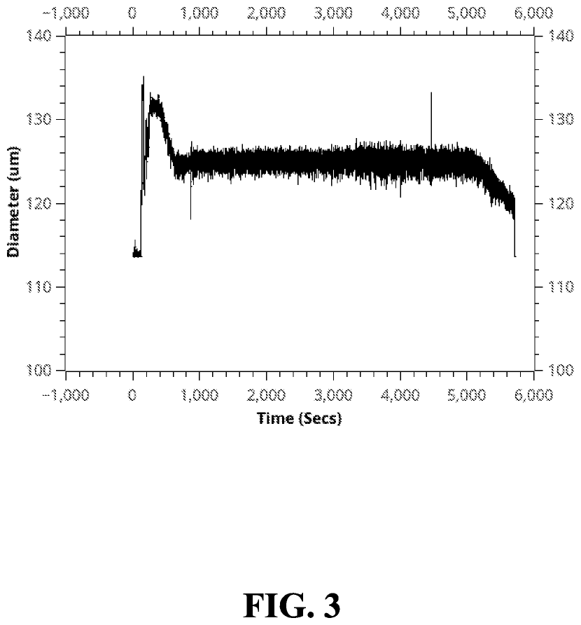

FIG. 3 is a diagram showing the change of the largest outer diameter measured by two adjacent optical fiber micrometers after the experiment of the present invention. The curve of outer diameter dimensional change in the diagram is the largest outer diameters from the computation results based on the measurements by the two optical micrometers. It can be seen from the diagram that before turn on the feedback control only the largest diameter of the initial drawing process is changing and downward, and the largest diameter obtained afterwards tends to be consistent, which means that the outer diameter uniformity is good, and the manufactured polygonal optical fiber can meet the specification. Therefore, the polygonal optical fiber drawing system of the present invention meets the objectives that it has an increased efficiency and conforms to the patent application requirements.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A drawing system for polygonal optical fiber, comprising: a clamping moving device, a furnace, a protective layer coating device, at least a protective layer drying system, and a fiber take-up device, all arranged from top to bottom; the clamping moving device clamping a polygonal preform rod and slowly moving the preform rod into the furnace; a polygonal optical fiber extracted from bottom of the furnace passing sequentially through the protective layer coating device, the protective layer drying system, and finally the fiber take-up device controlling drawing speed of the polygonal optical fiber, characterized in that: at least two optical fiber micrometers being disposed between the furnace and the protective layer coating device, and the two optical fiber micrometer respectively measuring two outer diameters of different sizes of the polygonal optical fiber; the fiber take-up device adjusting the drawing speed according to a plurality of measurement results of the optical fiber micrometers.

2. The drawing system for polygonal optical fiber according to claim 1, wherein the two outer diameters of the different sizes are the largest and smallest outer diameters of the polygonal optical fiber.

3. The drawing system for polygonal optical fiber according to claim 1, wherein two adjacent optical fiber micrometers are disposed at an angle of 10 to 60 degrees.

4. The drawing system for polygonal optical fiber according to claim 1, wherein when the polygonal optical fiber is quadrilateral, the two adjacent optical fiber micrometers are disposed at an angle of 33 to 57 degrees.

5. The drawing system for polygonal optical fiber according to claim 1, wherein when the polygonal optical fiber is hexagonal, the two adjacent optical fiber micrometers are disposed at an angle of 21 to 39 degrees.

6. The drawing system for polygonal optical fiber according to claim 1, wherein when the polygonal optical fiber is octagonal, the two adjacent two optical fiber micrometers are disposed at an angle of 16.5 to 28.5 degrees.

7. The drawing system for polygonal optical fiber according to claim 1, wherein the plurality of the fiber optic micrometers is located adjacent to an exit region of the furnace.

8. The drawing system for polygonal optical fiber according to claim 1, wherein the fiber optic micrometer is a laser micrometer.

9. The drawing system for polygonal optical fiber according to claim 1, wherein at least a protective layer micrometer is disposed between the protective layer drying system and the fiber take-up device.

10. The drawing system for polygonal optical fiber according to claim 9, wherein the protective layer micrometer is a laser micrometer.
